(19) United States
(12) Patent Application Publication
(10) Pub. No.: US 2025/0364009 A1
(43) Pub. Date: Nov. 27, 2025

(54) MAGNETIC RECORDING APPARATUS WITH HEAT-ASSISTED READ PROCESS

(71) Applicant: Western Digital Technologies, Inc., San Jose, CA (US)

(72) Inventor: Andreas Moser, San Jose, CA (US)

(21) Appl. No.: 18/673,038

(22) Filed: May 23, 2024

(51) Int. Cl. G11B 5/73; G11B 5/00; G11B 5/012; G11B 5/66; G11B 13/08

(52) U.S. Cl. CPC G11B 5/7369; G11B 5/012; G11B 5/66; G11B 5/7375; G11B 13/08; G11B 2005/0021

(57) ABSTRACT

A magnetic recording apparatus is described that provides heat-assisted reading of data from magnetic recording media. A magnetic recording medium configured to facilitate the heat-assisted reading is also described. The magnetic recording medium includes a ferrimagnetic capping layer above a magnetic recording layer, with the capping layer configured to enhance a magnetic field emanating from the magnetic recording layer during a read operation or process. The ferrimagnetic capping layer may include at least one rare earth metal and at least one transition metal and, in an illustrative example, the ferrimagnetic capping layer includes TbFeCo. The magnetic recording medium may also include additional layers, such as a soft underlayer (SUL) and a heatsink layer. The magnetic recording apparatus may include both a heat-assisted read head and a heat-assisted write head. The SUL is configured to provide a return path for magnetic flux during read and write operations.

### FIELD

The disclosure relates, in some aspects, to magnetic recording media and a magnetic recording apparatus for use with magnetic recording media. More specifically, but not exclusively, the disclosure relates to magnetic recording media and to magnetic recording read/write heads configured for use with heat-assisted magnetic recording (HAMR).

### INTRODUCTION

Magnetic storage systems, such as a hard disk drive (HDD), are utilized in a wide variety of devices in stationary and mobile computing environments. Examples of devices that incorporate magnetic storage systems include data center servers, desktop computers, portable notebook computers, portable hard disk drives, high-definition television (HDTV) receivers, television set-top boxes, video game consoles, and portable media players.

A typical disk drive includes magnetic storage media in the form of one or more flat disks. The disks are generally formed of few main substances, namely, a substrate material that gives it structure and rigidity, a magnetic recording layer that holds the magnetic impulses or moments that store digital data, and media overcoat and lubricant layers to protect the magnetic recording layer. The typical disk drive also includes a read head and a write head, generally in the form of a magnetic transducer which can sense and/or change the magnetic moments stored on the recording layer of the disks.

Heat Assisted Magnetic Recording (HAMR) systems can increase the areal density of information recorded on various magnetic media. To achieve higher areal density for magnetic storage, smaller magnetic grain sizes (e.g., less than 6 nanometers (nm)) may be required. In HAMR, high temperatures are applied to the media during writing data to facilitate recording to the small grains, which have high magnetic anisotropy. The high temperatures may be achieved using a near field transducer that is coupled to a laser diode of a slider of a HAMR disk drive for use in writing data into the magnetic recording layers.

Aspects of the present disclosure are instead directed to improvements in the reading of data from the magnetic recording layers of the disk, including improvements in the structure of the magnetic recording disks and the configuration of the read components of the slider to, e.g., improve the linear density capability (LDC) and the areal density capability (ADC) of the magnetic recording media or to achieve other advantages and improvements.

### SUMMARY

The following presents a simplified summary of some aspects of the disclosure to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In one aspect, a data storage device is provided that includes a magnetic recording medium and a magnetic recording apparatus. The magnetic recording medium includes: a substrate; a magnetic recording layer on the substrate; and a ferrimagnetic capping layer on the magnetic recording layer. The magnetic recording apparatus includes: a heat-assisted writer configured to write information to the magnetic recording layer of the magnetic recording medium during a write operation; and a heat-assisted reader configured to read information from the magnetic recording layer of the magnetic recording medium during a read operation.

In another aspect, a data storage device is provided that includes: a read head to detect a magnetic field emanating from a magnetic recording medium; and a heat source adjacent to the read head. The magnetic recording medium includes: a magnetic recording layer for storage of data bits in magnetic domains of the magnetic recording layer, and a read assistive layer over the magnetic recording layer. The read assistive layer is disposed between the magnetic recording layer and the read head, at least during a read operation. During the read operation, the heat source is operative to heat the read assistive layer of the magnetic recording media to enhance the magnetic field emanating from the magnetic recording layer.

In yet another aspect, a magnetic recording medium is provided that includes: a substrate; a soft underlayer (SUL) on the substrate, the SUL comprising a soft magnetic material; a heatsink layer on the substrate; a magnetic recording layer on the heatsink layer; and a ferrimagnetic capping layer on the magnetic recording layer.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. Similarly, while certain implementations may be discussed below as device, system, or method implementations, it should be understood that such implementations can be implemented in various devices, systems, and methods.

### BRIEF DESCRIPTION OF THE DRAWINGS

A more particular description is included below with reference to specific aspects illustrated in the appended drawings. Understanding that these drawings depict only certain aspects of the disclosure and are not therefore to be considered to be limiting of its scope, the disclosure is described and explained with additional specificity and detail through the use of the accompanying drawings, in which:

FIG. 1 illustrates a side cross-sectional view of a magnetic recording media and a reader along with various magnetic fields emanating from the magnetic recording media.

FIG. 2 illustrates a side cross-sectional view of a recording media and a heat-assisted reader along with various magnetic fields, wherein the recording media includes a ferrimagnetic capping layer in accordance with an embodiment of the disclosure.

FIG. 3 illustrates a top plan view of a disk drive in accordance with an embodiment of the disclosure.

FIG. 4 illustrates a profile view of a slider and a disk in accordance with an embodiment of the disclosure, wherein the disk includes a ferrimagnetic capping layer and the slider includes a heat-assisted reader.

FIG. 5 is a side schematic view of an exemplary HAMR medium that includes, among other layers, a ferrimagnetic capping layer in accordance with an aspect of the disclosure.

FIG. 6 is a flowchart of an exemplary process for fabricating a HAMR medium that includes a ferrimagnetic capping layer, in accordance with some aspects of the disclosure.

FIG. 7 is a block diagram of an exemplary data storage device that includes a heat-assisted read head and a heat-assisted write head, as well as a disk with a ferrimagnetic capping layer, in accordance with an aspect of the disclosure.

FIG. 8 is a block diagram of an exemplary data storage device that includes a magnetic recording apparatus with a heat source adjacent to a read head, as well as a disk with a read assistive layer over a magnetic recording layer, in accordance with an aspect of the disclosure.

FIG. 9 illustrates an exemplary magnetic recording medium in accordance with an aspect of the disclosure.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures, and techniques may not be shown in detail in order not to obscure the aspects of the disclosure.

The present disclosure describes a magnetic recording apparatus and magnetic recording medium in which heat is used to assist in the reading of data from the magnetic recording medium, and which may be used in conjunction with heat-assisted write operations. Some embodiments are directed to a HAMR data storage device. Note that HAMR is a type of Energy-Assisted Magnetic Recording (EAMR), which is a broader term that covers HAMR as well as Microwave Assisted Magnetic Recording (MAMR). At least some aspects of the present disclosure are not limited to HAMR and are more broadly applicable to EAMR. Systems that exploit energy-assisted recording within perpendicular magnetic recording (PMR) media may be referred to as ePMR systems. For the sake of simplicity, the various embodiments are described with respect to a HAMR implementation. However, the heat assisted reader embodiments may be implemented in non HAMR implementations such as other EAMR implementations, or in magnetic recording implementations without the use of energy assistance.

In one aspect, a data storage device is provided that includes a magnetic recording medium and a magnetic recording apparatus both of which are configured to provide and facilitate heat-assisted read operations as well as heat-assisted write operations. The magnetic recording medium has a substrate, a magnetic recording layer on the substrate, and a ferrimagnetic capping layer on the magnetic recording layer. The magnetic recording apparatus has a heat-assisted write head configured to write information to the magnetic recording layer of the magnetic recording medium during a write operation, and a heat-assisted read head configured to read information from the magnetic recording layer of the magnetic recording medium during a read operation. The ferrimagnetic capping layer of the magnetic recording medium may include at least one rare earth (RE) metal and at least one transition metal (TM) and, in an illustrative example, the ferrimagnetic capping layer is TbFeCo. In other examples, the RE of the ferrimagnetic capping layer may be Gd, Tb or Dy. The TM may be, for example, FeCo, or just Co, or just Fe. In another illustrative example, the ferrimagnetic capping layer is GdTbFe. The magnetic recording medium may include additional layers, such as an adhesion layer, a soft underlayer (SUL), a seed layer, a heatsink layer, a thermal resistive layer, and an MgO—TiO underlayer beneath the magnetic recording layer. The SUL is configured to provide a return path for magnetic flux during read and write operations. A carbon overcoat may be provided on the ferrimagnetic capping layer with a lubricant on the carbon overcoat.

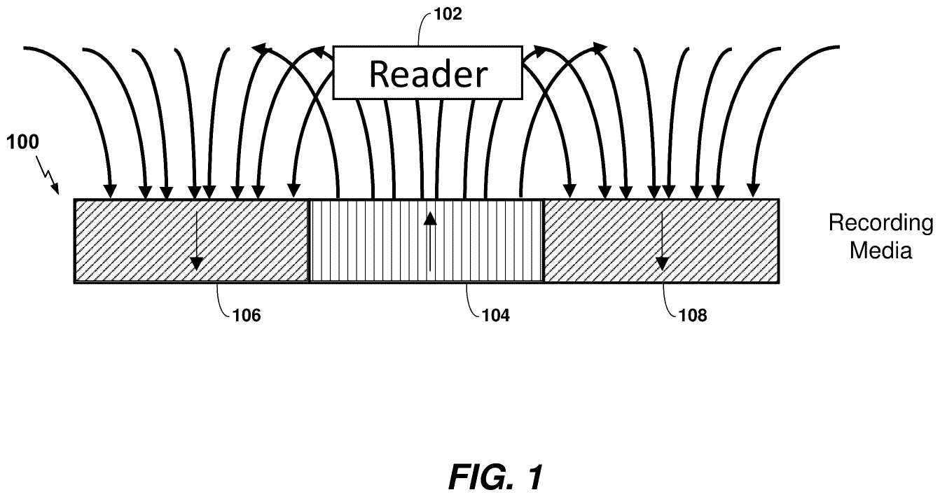

FIG. 1 illustrates a HAMR media 100 configured for use with heat-assisted writes but not heat-assisted reads. The HAMR media 100 is shown in cross-section to illustrate a cross-track view cut through the media. Note that each recording track extends in a direction perpendicular to the page. A reader 102 (which may include a read head) of a read/write slider is shown schematically above the HAMR media 100. More specifically, reader 102 is shown above track 104, which is between parallel tracks 106 and 108. As indicated by an upward arrow within track 104, track 104 has a magnetic moment pointing toward reader 102. The upward arrow denotes, for example, that track 104 has a positive magnetic moment that encodes a binary 1. As indicated by downward arrows within tracks 106 and 108, those tracks both have negative magnetic moments pointing away from the reader 102, which indicate, for example, that the tracks encode a binary 0. Note also that the positive magnetic moment of track 104 produces magnetic field lines that extend upward into and around reader 102. The negative magnetic moments of tracks 106 and 108 produce magnetic field lines that extend downwardly into those tracks at locations offset to the left and right of the reader.

In the example of FIG. 1, reader 102 is in the process of reading back data encoded in track 104. As illustrated, most of the magnetic field signal applied to reader 102 emanates from track 104. Some of the magnetic field signals from tracks 106 and 108 may also be detected by reader 102 and will appear as noise in a read channel. (See, e.g., the rightmost magnetic field arrows corresponding to track 106 and the leftmost magnetic field arrows corresponding to track 108, which extend into the reader 102.) In this regard, the magnetic field emanating from a magnetic recording media decays relatively slowly (e.g., dipole: ˜1/r³), and so a magnetic field emanating from an adjacent track (e.g., track 108) may interfere with the magnetic field emanating from a track being read (e.g., track 104). The resulting noise reduces the signal-to-noise ratio (SNR) and thus reduces the capability of the read channel to correctly decode the information being read from track 104. To mitigate the problem, tracks 106 and 108 should be spaced farther apart from track 104, which thus corresponds to a lower track density. Alternatively, the linear density can be reduced. Both alternatives reduce the areal density capability (ADC) of the recording system.

Although not shown in FIG. 1, the system may also include a writer to initially write (i.e., store) data into the tracks 104, 106, and 108 so the data can be read back later (i.e., retrieved). The writer may be a heat-assisted writer (e.g., a HAMR writer) that heats a precise location of the tracks as data is written. As explained above, HAMR permits higher areal densities.

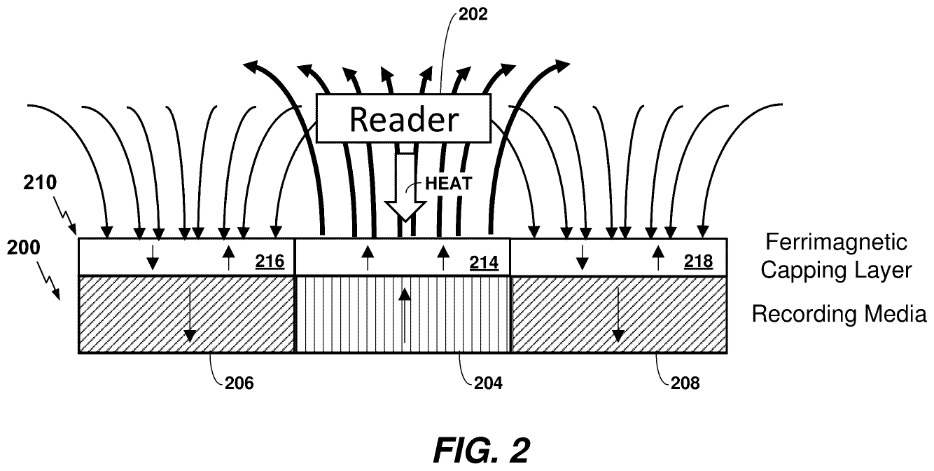

FIG. 2 illustrates a HAMR media 200 configured for use with heat-assisted writes and heat-assisted reads, according to various embodiments. The HAMR media is again shown in cross-section to illustrate a cross-track view cut through the media with each recording track extending perpendicular to the page. A heat-assisted reader 202 (which may include a read head and a heat source) of a read/write slider is shown schematically above the HAMR media 200. More specifically, reader 202 is shown above a track 204, which is between parallel tracks 206 and 208. As indicated by an upward arrow within track 204, track 204 has a magnetic moment pointing toward the reader 202. As indicated by downward arrows within tracks 206 and 208, those tracks both have negative magnetic moments pointing away from reader 202. The positive magnetic moment of track 204 produces magnetic field lines that extend upward into and around the reader 202. The negative magnetic moments of tracks 206 and 208 produce magnetic field lines that extend downwardly into those tracks at locations offset to the left and right of the reader.

Additionally, a ferrimagnetic capping layer 210 is provided on the HAMR media 200, which may be, e.g., formed of TbFeCo. The ferrimagnetic capping layer 210 includes a portion 214 on the track 204, a portion 216 on the track 206, and a portion 218 on the track 208. The ferrimagnetic layer 210 is designed to provide an effective magnetic moment that is relatively small at drive temperatures (i.e., the ordinary operating temperature within a hard disk drive, which may be somewhat higher than room temperature), but which increases as the media is heated by the heat-assisted reader 202. As the reader 202 reads back data encoded in track 204, the reader applies localized heat to capping portion 214. During this read process, little or no heat is applied to the adjacent capping portions 214 and 218 or to track 204 beneath capping portion 214. Note that in FIG. 2, capping portion 216 is shown with two internal arrows, one pointing up and the other down, to illustrate that capping portion 216 has no net magnetic moment when not heated. Likewise, capping portion 218 is shown with two internal arrows, one pointing up and the other down, to illustrate that capping portion 218 also has no net magnetic moment when not heated. However, heated capping portion 214 is shown with two internal arrows both pointing up to illustrate that capping portion 214 has a net magnetic moment because it has been heated to a temperature sufficient to generate a net magnetic moment.

As in FIG. 1, most of the magnetic field signal applied to the reader 202 emanates from track 204. However, due to the additional magnetic moment provided by the capping layer portion 214, which is heated by reader 202, the magnetic field signal applied to reader 202 from track 204 is much larger than in FIG. 1, as indicated by the large and bold magnetic field arrows. The signal read by the reader 202 is thus stronger. This is because (1) a higher magnetic remanence (MrT) in the ferrimagnetic portion 214 due to the higher temperature and (2) a relatively small effective spacing between media track 204 and the read head 202 (as compared to the spacing/distance between tracks 206, 208 and the read head 202).

Note that the read-assist temperature should be set low enough so that it does not lead to any significant degradation of the recorded data within track 204 or within the adjacent tracks 206 and 208. That is, the read-assist temperature during a read operation (e.g., 100° C.) is set much lower than the write-assist temperature during a write operation in the HAMR example (e.g., 300-400° C.), but is set high enough to assist the read operation (e.g. 50° C. above normal drive temperature).

As in FIG. 1, some of the magnetic field signals from tracks 206 and 208 may also detected by reader 202 and will appear as noise in the read channel. (See, the rightmost magnetic field arrows corresponding to track 206 and the leftmost magnetic field arrows corresponding to track 208, which extend into the reader 202.) However, since the signal from track 204 is now stronger than the corresponding signal of FIG. 1, the SNR is better and the noise from the adjacent tracks 206 and 208 can be more easily rejected. This allows tracks 206 and 208 to be spaced closer to track 204, which thus corresponds to a higher track density to permit an increase in LDC/ADC. In this regard, note that the ferrimagnetic layer portions 216, 218 (that are on top of tracks 206, 208) remain at drive temperatures while track 204 is read, and therefore tracks 206 and 208 have no, or relatively low, net magnetic moments as they are not heated. As such, the signals from tracks 206 and 208 in the read head 202 are relatively weak because of (1) the lower MrT in 216 and 218 (as compared to the higher MrT of 214) and (2) the effective larger spacing between media 200 and the read head 202 (due to the intervening capping layer 210). As a result, the noise in the read channel, which is generated by tracks 206 and 208, is relatively small, which allows for an increase in linear track density and hence an increase LDC/ADC.

In one example, track 204 may be heated by a heat source that includes a laser and a near field transducer (NFT), which are integrated into the read head. For example, the laser may provide optical power, which the NFT converts to heat. In some aspects, the NFT may be regarded as the heat source (although the NFT operates more as an optical transducer). An advantage of an NFT implementation is that the NFT can generate much higher cross-track thermal gradients than using a magnetic field at the relevant distances. Thermal gradients in the cross-track direction can be 10° K/nanometer (nm) or higher. If the temperature increase of the media is 50° K, the temperature drops within 5 nanometers (nm) back to the normal drive temperature, thus reducing the effective reader width. In some embodiments, to target a particular track for reading, the thermal spot size from the heat source (e.g., NFT) is conformal with the recording track width configured for the media. In some examples, a track density exceeding 1,000 kilo-tracks per inch (kTPI) may be achieved. Overall, the use of heat-assisted writing and heat-assisted reading using NFTs for both helps to achieve a good SNR, while also providing thermal stability and writability. As the term is used herein, a heat-assisted reader includes a read head and an adjacent heat source, which may be an NFT. The heat-assisted reader may include additional components such as a laser and a waveguide for use with the NFT of the reader. As the term is used herein, a heat-assisted writer includes a write head and an adjacent heat source, which may be an NFT. The heat-assisted writer may also include additional components such as a laser and a waveguide for use with the NFT of the writer.

### Exemplary Read/Write head With Heat-Assisted Reads and Writes

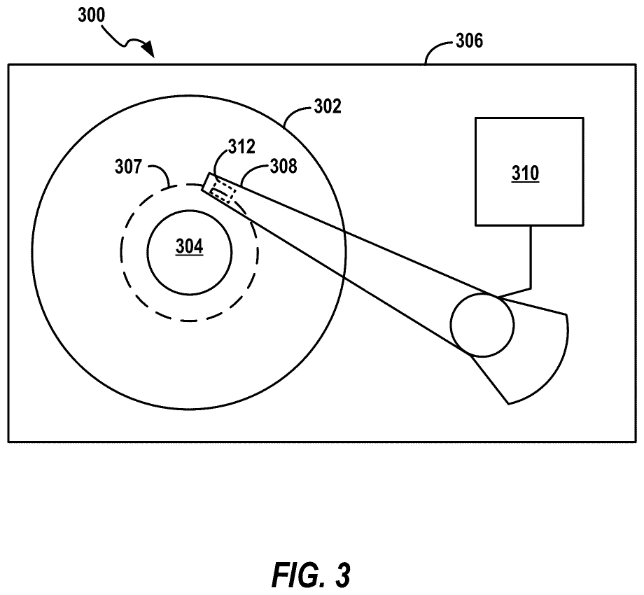

FIG. 3 illustrates a disk drive 300 configured for both heat-assisted reading and heat-assisted recording. The disk drive 300 includes one or more media 302, a spindle assembly 304, a drive housing 306, a slider 308, and control circuitry 310. The slider 308 may include a slider head 312 (shown in dashed lines as it is on the underside of the distal end of the slider 308). The slider 308 may be used to position one or more lasers (not shown in FIG. 3). The media 302 may be configured to store data. The media 302 may be a magnetic recording medium, such as a HAMR medium with a ferrimagnetic capping layer, in the form of a disk, or any other suitable means for storing data. The media 302 is positioned on the spindle assembly 304 that is mounted to the drive housing 306. Data may be stored along tracks in the magnetic recording layer of the media 302. The reading and writing of data are accomplished with a read element and a write element located with the slider 308. Both the reads and write elements are used to alter the properties of the magnetic recording layer of the media 302 to thereby write information thereto and subsequently read the information. During the operation of the disk drive 300, a spindle motor (not shown) rotates the spindle assembly 304 and thereby rotates the media 302. The slider 308 and the lasers (not shown) may be positioned over the media 302 at a particular location along a desired disk track, such as track 307 shown in dashed lines. The positions of the slider 308 and the laser relative to the media 302 may be controlled by the control circuitry 310.

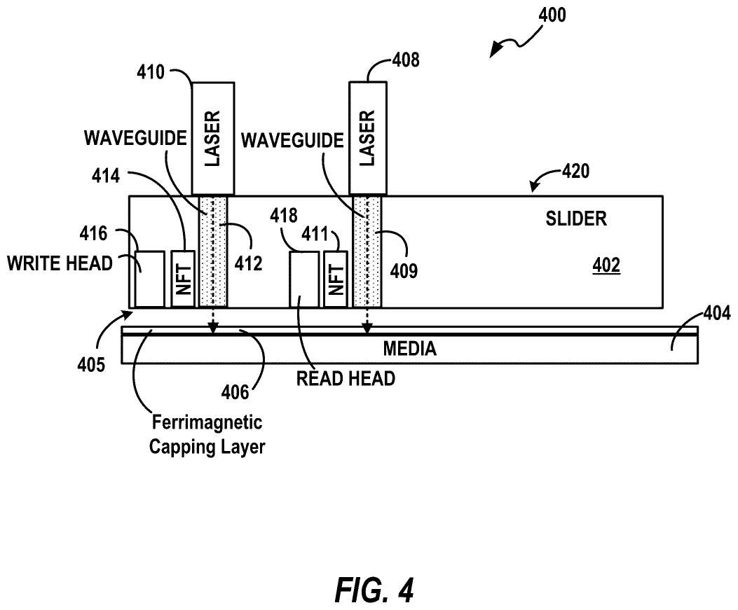

FIG. 4 illustrates a side view of an exemplary assembly 400 that includes a slider 402 and a HAMR medium 404 with a ferrimagnetic capping layer 406 (and other layers, not shown). The assembly 400 includes a read laser 408, a corresponding read laser waveguide 409, a corresponding read NFT 411, and a read head 418 (which collectively may be referred to as a heat-assisted reader). The assembly 400 further includes a write laser 410, a corresponding write laser waveguide 412, a corresponding write NFT 414, and a write head 416 (which collectively may be referred to as a heat-assisted writer). The assembly 400 is positioned over the HAMR media 404. The slider 402 may be one component or several components. For example, the slider 402 may include a slider and a slider head (not separately shown) and may further include a sub-mount. In some implementations, the slider head may be a separate component mounted to the slider 402. The various lasers, waveguides, NFTs, the write head, and the read head may be implemented in the slider, the slider head, or combinations thereof.

The bottom (first) surface 405 of the slider 402 faces the media 404. The bottom surface 405 may be referred to as an air-bearing surface (ABS). The slider 402 also includes a top (second) surface 420 that faces away from the media 404. The lasers 408 and 410 are coupled to the slider 402, and in some examples, to a sub-mount (not shown). The waveguides, NFTs, the write head 416, and the read head 418 may be located near or along the ABS 405 of the slider 402. The write head 416 may be configured as a writing element or means for writing data on the media 404, and the read head 418 may be configured as a reading element or means for reading data on the media 404. In some examples, a single laser is instead employed to provide light for both reading and writing with a suitable optical switching coupler to selectively couple light from the single laser into the read waveguide 409 during a read operation or into the write waveguide 412 during a write operation.

The write laser 410 is configured to generate and transmit light energy (e.g., a write laser beam) into the write waveguide 412, which directs light energy to and/or near the write NFT 414, which is near the ABS 405 of the slider 402. Upon receiving and/or being near the light energy, the write NFT 414 may cause a portion of the media 404 to heat up, and/or the light energy traveling through the waveguide may heat a portion of the media 404. For example, upon receiving and/or being near the light energy, the write NFT 414 may generate localized heat that heats a portion of the media by an amount sufficient to permit HAMR writing of data into the media. Thus, the light energy may travel through the write waveguide 412 such that the write NFT 414 emits heat to a portion of the media 404. The heat-assisted write temperature may be in the range of about 350° C. to 400° C. As noted above, in some embodiments, the writer may not rely on the assistive effect of HAMR. Thus, other assistive mechanisms such as may be used (e.g., MAMR) or no assistive mechanism may be used as all, as in the case of conventional magnetic recording. Thus, the write laser 410, the write waveguide 412, the NFT 414 and other HAMR related components may be absent or substituted by other elements in certain embodiments.

The read laser 408 is configured to generate and transmit light energy (e.g., a read laser beam) into the read waveguide 409, which directs light energy to and/or near the read NFT 411, which is near the ABS 405 of the slider 402. Upon receiving and/or being near the light energy, the read NFT 411 may cause a portion of the ferrimagnetic capping layer 406 to heat up, and/or the light energy traveling through the waveguide may heat a portion of the ferrimagnetic capping layer 406. For example, upon receiving and/or being near the light energy, the read NFT 411 may generate localized heat that heats a portion of the ferrimagnetic capping layer 406 to provide the above-described heat-assisted read. Thus, the light energy may travel through the read waveguide 409 such that the read NFT 411 emits heat to a portion of the ferrimagnetic capping layer 406. The heat-assisted read temperature may be in the range of about 100°° C. to 150° C. Note that the NFTs may be omitted in some embodiments with other heating components used instead, though, as noted above, an NFT has important advantages.

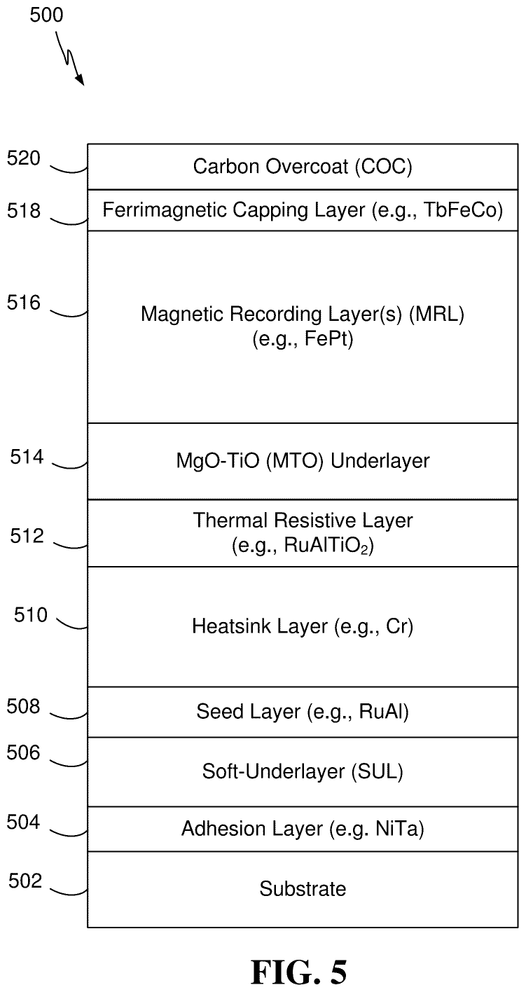

FIG. 5 is a side schematic view of an exemplary HAMR medium 500 in accordance with an aspect of the disclosure. The HAMR medium 500 of FIG. 5 has a stacked structure with a substrate 502 at a bottom/base layer, an adhesion layer 504 (which may be formed, e.g., of NiTa) on the substrate 502, a soft underlayer (SUL) 506 on the adhesion layer 504, a seed layer 508 (which may be formed, e.g., of RuAl) on the SUL 506, a heatsink layer 510 (which may be formed, e.g., of Cr) on the seed layer 508, a thermal resistive layer 512 (which may be formed, e.g., of RuAlTiO₂), an MgO—TiO (MTO) underlayer 514 on the thermal resistive layer 512. A magnetic recording layer (MRL) 516 (which may be formed, e.g., of FePt) is on the MTO underlayer 514. A capping layer 518 (which may be formed, e.g., of a ferrimagnetic material such as TbFeCo). A carbon overcoat layer (COC) 520 is on the capping layer 518.

Note that the layers in the figure (or in other figures herein) are not shown to scale. Note also that the terms “above,” “below,” “on,” and “between” as used herein refer to a relative position of one layer with respect to other layers. As such, one layer deposited or disposed on, above, or below another layer may be directly in contact with the other layer or may have one or more intervening layers. Moreover, one layer deposited or disposed between layers may be directly in contact with the layers or may have one or more intervening layers.

In some aspects, the layers have the following thicknesses: the substrate 502 thickness is in the range of 0.5 mm to 0.635 mm; the adhesion layer 504 thickness is in the range of 45 nm to 180 nm; the SUL 506 thickness is in the range of 85 nm to 130 nm; the seed layer 508 thickness is in the range of 2 nm to 54 nm; the heatsink layer 510 thickness is in the range of 55 nm to 100 nm; the thermal resistive layer 512 thickness is in the range of 0.5 nm to 2.0 nm; the MTO underlayer 514 has a thickness is in the range of 1 to 5.5 nm; the MRL 516 thickness is in the range of 8 nm to 11 nm; the ferrimagnetic capping layer 518 thickness is in the range of 1 nm to 5 nm or, in some cases, in the range of 1 nm-3 nm. The COC 520 thickness is in the range of 20 Å to 40 Å; the lubricant layer thickness (if provided) is in the range of 7 Å to 9.5 Å. The above noted thicknesses are provided as one or more examples. However, other suitable thicknesses can be used. For example, otherwise routine experimentation can be used to determine suitable or preferred layer thicknesses and/or suitable or preferred compound percentage concentrations for use within practical HAMR systems based on the particular characteristics of the system, such as its operating temperature, the desired areal density of data, etc.

In some examples, substrate 502 has an outer diameter (i.e., OD) of about 97 mm and a thickness of about 0.5 mm. In other examples, the OD may be 95 mm or 95.1 mm. (Generally speaking, such disks are all referred to as “3.5 inch” disks.)

In some aspects, the substrate 502 may be made of one or more materials such as an Al alloy, NiP-plated Al, glass, glass ceramic, and/or combinations thereof.

In some aspects, the adhesion layer 504 (which might alternatively be referred to as a pre-seed layer) is used to reduce delamination of layers or films deposited over the adhesion layer. The adhesion layer 504 may be a metallic alloy, such as NiTa (as shown, or CrTi), etc.

In some aspects, the SUL 506 can be made of one or more materials, such as Co, Fe, Mo, Ta, Nb, B, Cr, or other soft magnetic materials, or combinations thereof. The SUL 506 may include an amorphous compound or combination of Co and Fe (e.g., a CoFe alloy) with the addition of one or more elements from Mo, Nb, Ta, W, and B. The SUL 506 may be configured to support the magnetization of the magnetic recording layer structure 516 during data storage operations. More specifically, the SUL 506 may be configured to provide a return path for magnetic flux (not shown in FIG. 506) applied by a write head during a write operation and by a read head during a read operation. Although various materials may be used to form the SUL 506, the SUL is preferably configured with a material that has a saturated magnetic flux density (Bs) greater than 1.2 Tesla (T) and, for example, has a B_{S} in the range of 1.4 T to 1.6 T. CoZrWMo is one example of a material that has such a high B_{S} value.

In some aspects, the seed layer 508 is used to create a growth template for the subsequently deposited films including the heatsink layer 510 and the MRL 516, and to provide a correct crystallographic orientation, e.g., L1₀. Functional goals for the seed layer 508 include small grain size and good crystallographic texture, both of which may be desirable for good media recording performance.

In some aspects, the heatsink layer 510 can be made of one or more materials such as Cr, as shown, or Ag, Al, Au, Cu, Mo, Ru, W, CuZr, MoCu, AgPd, CrRu, CrV, CrW, CrMo, CrNd, NiAl, NiTa, combinations thereof, and/or other suitable materials known in the art.

In some aspects, the thermal resistive layer 512 is deposited to provide thermal resistance to the heatsink layer 510. As noted above, the thermal resistive layer 512 may be etched to reduce roughness.

In some aspects, the MTO underlayer 514 is provided, e.g., to provide a thermal barrier and to assist in nucleation to permit proper crystal growth within the MRL 516 so that the MRL 516 will have good crystallographic texture with small grains.

In some aspects, the MRL 516 includes one or more magnetic recording layers for storing data magnetically, not explicitly shown in FIG. 5. For example, the MRL 516 may include magnetic recording sub-layers and exchange control sub-layers (ECLs). Collectively, the sub-layers form an MRL structure 516 that may be, e.g., 100-200 angstroms (Å) thick. In some aspects, the MRL 516 may be made of FePt. In some aspects, the MRL 516 may be made instead of an alloy selected from FePtY, where Y is a material selected from Cu, Ni, and combinations thereof. In other aspects, the MRL 516 may be made instead of a CoPt alloy. In some aspects, the MRL 516 may be formed of high anisotropy Llo FePt with segregants such as C, BN, SiO₂, Ag, and combinations thereof. In some aspects, the MRL is a four-layer MRL. Each layer of the MRL may have segregants with the amount of segregant varying from layer to layer within the MRL.

In some aspects, the ferrimagnetic TbFeCo capping layer 518 may be made instead of other combinations of RE metals and TM with at least one RE metal and at least one TM. In some aspects, a relative concentration of the RE and the TM in the ferrimagnetic capping layer is selected or configured to provide a compensation temperature (T_{comp}) high enough so there will be no net magnetic field from the capping layer at normal drive temperatures but that a net magnetic field will arise as the capping layer is heated above normal drive temperatures. The compensation temperature is the temperature where the moments of two opposite RE and TM sublattices in the TbFeCo compensate each other so there is not net field. Within TbFeCo, the compensation temperature can be shifted or adjusted by varying the Tb-to-FeCo ratio. This also permits the saturation magnetization Ms and the coercivity Hc of the compound to be adjusted. The heat-assisted reader is configured to heat the capping layer to a temperature between the compensation temperature (T_{comp}) and a higher Curie temperature (T_{C}) during read operations to facilitate the ferrimagnetic effect. In one example, the TbFeCo alloy is configured so that its T_{comp} is in the range of 30° C. to 70° C. The read head is configured to heat the TbFeCo capping layer into a temperature range of 100° C. to 150° C.

In some examples, the capping layer 518 might be a bi-layer structure having a top layer including TbFeCo and a bottom layer including CoFe or Co, Pt, and/or Pd. In additional examples, bottom capping layer materials include any combination of Pt and Pd (e.g., alloys), or any of the following elements, alone or in combination: Au, Ag, Al, Cu, Ir, Mo, Ni, Os, Ru, Ti, V, Fe, Re, and the like.

In some aspects, if a lubricant layer is also provided on the COC 520, the lubricant layer (not shown in the figure) may be made of a polymer-based lubricant material.

The spacing between the top of the magnetic recording medium 500 and the read head, i.e., the head to media spacing (HUS), may be, for example, 10 nm. Generally speaking, the closer the media is to the read head, the stronger the read signal and the greater the SNR during a read, and so the HUS should be kept as small as feasible given other design constraints.

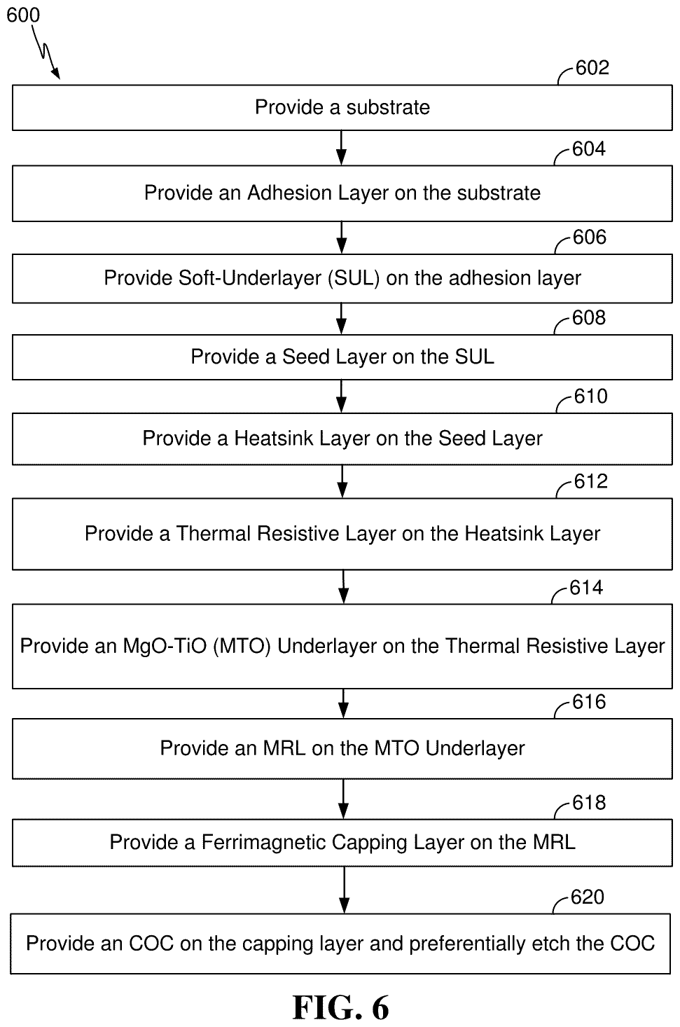

FIG. 6 is a flowchart of a process 600 for fabricating a HAMR medium with a ferrimagnetic capping layer in accordance with some aspects of the disclosure. In one aspect, process 600 can be used to fabricate the HAMR media described above in relation to FIG. 5. In block 602, the process provides a substrate. In block 604, the process provides an adhesion layer (which may be formed, e.g., of NiTa) on the substrate. In block 606, the process provides an SUL on the adhesion layer. In block 608, the process provides a seed layer (which may be formed, e.g., of RuAl) on the SUL. In block 610, the process provides a heatsink layer (which may be formed, e.g., of Cr) on the seed layer. In block 612, the process provides a thermal resistive layer (which may be formed, e.g., of RuAlTiO₂). In block 614, the process provides an MTO underlayer on the thermal resistive layer. In block 616, the process provides an MRL (which may be formed, e.g., of FePt) on the MTO underlayer. In block 618, the process provides a ferrimagnetic capping layer 318 (which may be formed, e.g., of TbFeCo or other combinations of RE metals and TMs) on the MRL. In block 620, the process provides a COC on the capping layer. Although not shown, the process may also provide a lubricant layer on the COC. Additional or alternative exemplary materials are listed above.

Thus, FIGS. 5 and 6 illustrate media and methods where a ferrimagnetic capping layer is provided that is formed, e.g., of TbFeCo or other combinations of RE metals and TMs.

### Additional Exemplary Methods and Embodiments

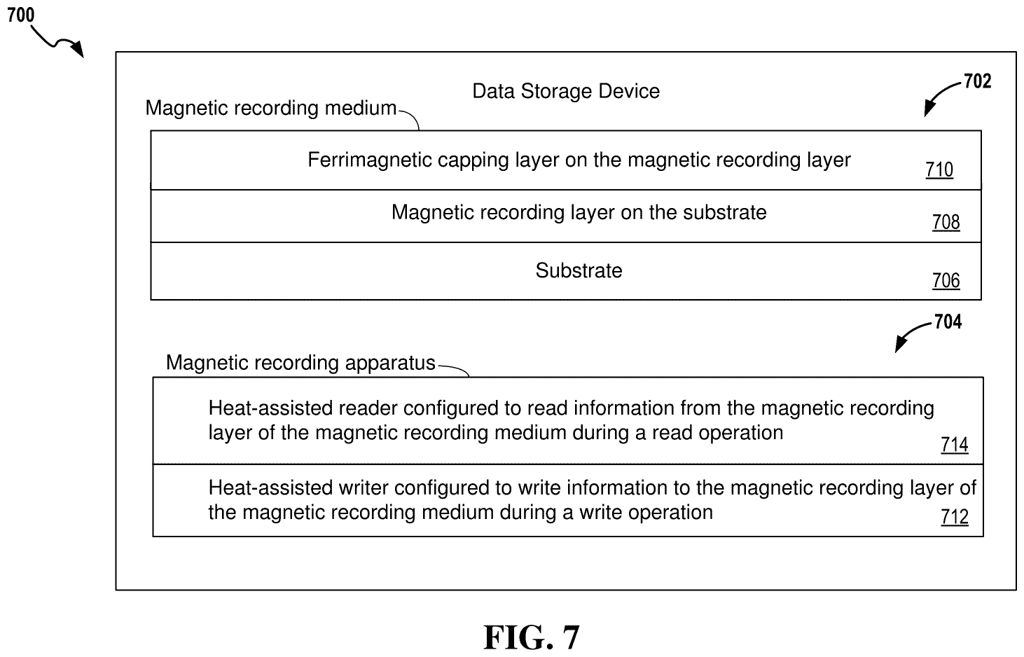

FIG. 7 is a block diagram of an exemplary data storage device 700 for HAMR in accordance with some aspects of the disclosure. The data storage device 700 includes: a magnetic recording medium 702 and a magnetic recording apparatus 704. The magnetic recording medium 702 includes a substrate 706 (e.g., an Al alloy, NiP-plated Al, glass, glass-ceramic); a magnetic recording layer 708 (e.g., FePt) on the substrate; and a ferrimagnetic capping layer 710 (e.g., TbFeCo) on the magnetic recording layer. The magnetic recording medium 702 may have various other layers, not shown in FIG. 7, but see FIG. 5, described above. The magnetic recording apparatus 704 includes: a heat-assisted writer 712 configured to write information to the magnetic recording layer of the magnetic recording medium during a write operation; and a heat-assisted reader 714 configured to read information from the magnetic recording layer of the magnetic recording medium during a read operation. See, FIG. 4 for an example of a heat-assisted writer (e.g., components 410, 412, 414, and 416) and a heat-assisted reader (e.g., components 408, 409, 411, and 418).

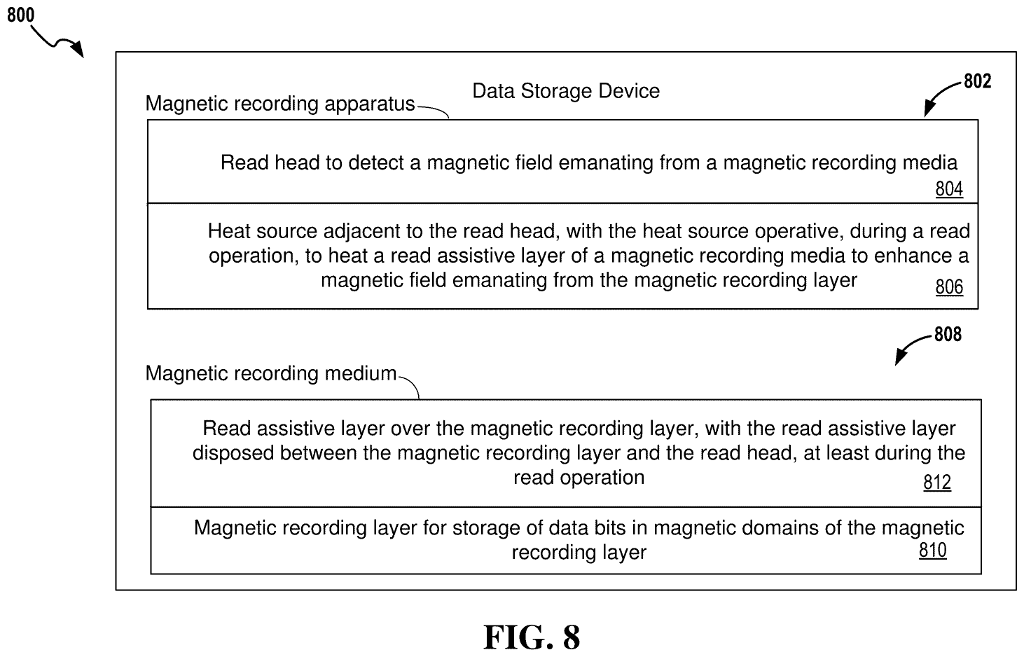

FIG. 8 is a block diagram of an exemplary data storage device 800 in accordance with some aspects of the disclosure. The data storage device 800 has a magnetic recording apparatus 802 that includes a read head 804 to detect a magnetic field emanating from a magnetic recording media, and a heat source 806 adjacent to the read head, with the heat source operative, during a read operation, to heat a read assistive layer of a magnetic recording media to enhance a magnetic field emanating from the magnetic recording layer. See, FIG. 4 for an example of a read head (e.g., read head 418) and a heat source (e.g., NFT 411). The data storage device 800 also includes a magnetic recording medium 808 that includes a magnetic recording layer 810 for storage of data bits in magnetic domains of the magnetic recording layer, and a read assistive layer 812 over the magnetic recording layer, with the read assistive layer disposed between the magnetic recording layer and the read head during the read operation. See, FIG. 4 for an example of a magnetic recording layer (e.g., media 404) and a read assistive layer (e.g., layer 406). The magnetic recording medium 808 may have various other layers, not shown in FIG. 8, but see FIG. 5, described above, for examples.

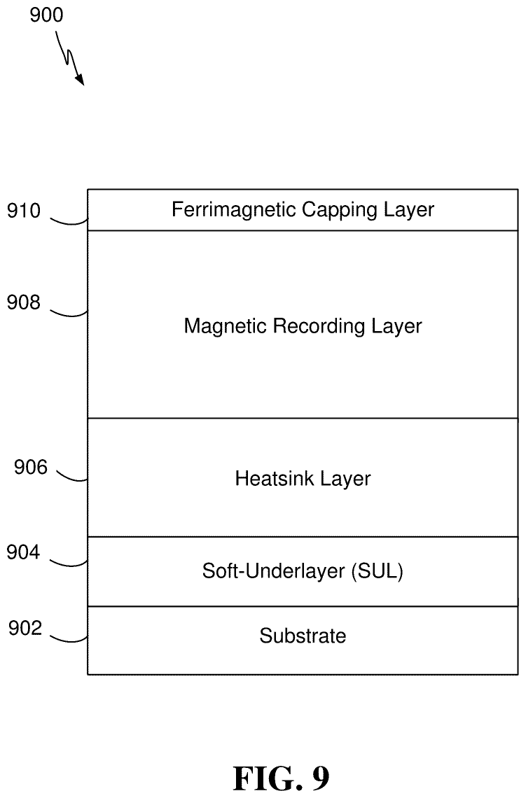

FIG. 9 is a block diagram of an exemplary magnetic recording medium 900 in accordance with some aspects of the disclosure. The magnetic recording medium 900 includes: a substrate 902 (e.g., an Al alloy, NiP-plated Al, glass, glass ceramic); an SUL 904 (e.g., Co, Fe, Mo, Ta, Nb, B, Cr, or other soft magnetic materials, or combinations thereof) on the substrate; a heatsink layer 906 (e.g., Cr) on the SUL; a magnetic recording layer 908 (e.g., FePt) on the heatsink layer; and a ferrimagnetic capping layer 910 on the magnetic recording. The ferrimagnetic capping layer 910 may include, e.g., at least one RE metal and at least one TM, and, in an illustrative example, the ferrimagnetic capping layer is TbFeCo. The ferrimagnetic capping layer 910 is configured and positioned to enhance a magnetic field emanating from the magnetic recording layer 908 during a read operation in which heat is applied to the ferrimagnetic capping layer. Note that the SUL 904 may be configured to support magnetization of the magnetic recording layer medium 900 during data storage operations. More specifically, the SUL 904 may be configured to provide a return path for a magnetic flux emanating from a read head during a read operation and from a write head during a write operation. The magnetic recording medium 900 may have various other layers, not shown in FIG. 9, but see FIG. 5, described above.

It shall be appreciated by those skilled in the art in view of the present disclosure that although various exemplary fabrication methods are discussed herein with reference to magnetic recording disks, the methods, with or without some modifications, may be used for fabricating other types of recording disks, for example, magneto-optical recording disks, or ferroelectric data storage devices.

Various components described in this specification may be described as “including” or made of certain materials or compositions of materials. In one aspect, this can mean that the component consists of the particular material(s). In another aspect, this can mean that the component comprises the particular material(s).

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. It is further noted that the term “over” as used in the present application in the context of one component located over another component, may be used to mean a component that is on another component and/or in another component (e.g., on a surface of a component or embedded in a component). Thus, for example, a first component that is over the second component may mean that (1) the first component is over the second component, but not directly touching the second component, (2) the first component is on (e.g., on a surface of) the second component, and/or (3) the first component is in (e.g., embedded in) the second component. The term “about ‘value X’”, or “approximately value X”, as used in the disclosure shall mean within 10 percent of the ‘value X’. For example, a value of about 1 or approximately 1, would mean a value in a range of 0.9-1.1. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range.

What is claimed is:

1. A data storage device comprising:
a magnetic recording medium comprising:
a substrate;
a magnetic recording layer on the substrate; and
a ferrimagnetic capping layer on the magnetic recording layer; and
a magnetic recording apparatus comprising:
a heat-assisted writer configured to write information to the magnetic recording layer of the magnetic recording medium during a write operation; and
a heat-assisted reader configured to read information from the magnetic recording layer of the magnetic recording medium during a read operation.

2. The data storage device of claim 1, wherein the ferrimagnetic capping layer of the magnetic recording medium comprises at least one rare earth metal and at least one transition metal.

3. The data storage device of claim 1, wherein the ferrimagnetic capping layer of the magnetic recording medium comprises TbFeCo.

4. The data storage device of claim 1, wherein the magnetic recording medium further comprises a soft underlayer (SUL) between the substrate and the magnetic recording layer, wherein the SUL is configured to provide a return path for magnetic flux from a write head during the write operation and for magnetic flux from a read head during the read operation.

5. The data storage device of claim 4, wherein the magnetic recording medium further comprises a heatsink layer between the SUL and the magnetic recording layer.

6. The data storage device of claim 1, wherein the heat-assisted reader comprises a read head and a heat source adjacent to the read head.

7. The data storage device of claim 6, wherein the heat source of the heat-assisted reader comprises a near field transducer (NFT).

8. The data storage device of claim 6, wherein the heat source of the heat-assisted reader is configured to apply heat at a target read location on the magnetic recording medium during a read operation, so that portions of the ferrimagnetic capping layer become magnetically aligned with one another at the target read location while portions of the ferrimagnetic capping layer adjacent to the target read location remain magnetically unaligned.

9. The data storage device of claim 6, wherein a size of a thermal spot from the heat source on the magnetic recording medium is conformal with a recording track width configured for the magnetic recording medium.

10. A data storage device comprising:
a read head to detect a magnetic field emanating from a magnetic recording medium;
a heat source adjacent to the read head; and
the magnetic recording medium comprising:
a magnetic recording layer for storage of data bits in magnetic domains of the magnetic recording layer, and
a read assistive layer over the magnetic recording layer;
wherein the read assistive layer is disposed between the magnetic recording layer and the read head, at least during a read operation, and
wherein, during the read operation, the heat source is operative to heat the read assistive layer of the magnetic recording medium to enhance the magnetic field emanating from the magnetic recording layer.

11. The data storage device of claim 10, wherein the read assistive layer comprises a ferrimagnetic capping layer on the magnetic recording layer.

12. The data storage device of claim 11, wherein the ferrimagnetic capping layer comprises at least one rare earth metal and at least one transition metal.

13. The data storage device of claim 11, wherein the ferrimagnetic capping layer comprises TbFeCo.

14. The data storage device of claim 10, further comprising:
a write head to apply a magnetic field to the magnetic recording medium to store the data bits in the magnetic domains of the magnetic recording layer; and
a second heat source adjacent to the write head to heat the magnetic recording medium while a magnetic field is applied during a write operation.

15. The data storage device of claim 14, wherein the second heat source comprises a near field transducer (NFT).

16. The data storage device of claim 10, wherein the magnetic recording medium further comprises a substrate, a heatsink layer, and a soft underlayer (SUL), with the SUL on the substrate, the heatsink layer on the SUL, and the magnetic recording layer on the heatsink layer.

17. The data storage device of claim 16, wherein the SUL is configured to provide a return path for magnetic flux from the read head.

18. The data storage device of claim 10, wherein the heat source adjacent to the read head comprises a near field transducer (NFT).

19. The data storage device of claim 10, wherein the heat source adjacent to the read head is configured to apply heat at a target read location on the magnetic recording medium during a read operation so that portions of the read assistive layer become magnetically aligned with one another at the target read location while portions of the read assistive layer adjacent to the target read location remain magnetically unaligned.

20. The data storage device of claim 10, wherein a size of a thermal spot from the heat source on the magnetic recording medium is conformal with a recording track width configured for the magnetic recording medium.

21. A magnetic recording medium comprising:
a substrate;
a soft underlayer (SUL) on the substrate, the SUL comprising a soft magnetic material;
a heatsink layer on the substrate;
a magnetic recording layer on the heatsink layer; and
a ferrimagnetic capping layer on the magnetic recording layer.

22. The magnetic recording medium of claim 21, wherein the ferrimagnetic capping layer of the magnetic recording medium comprises at least one rare earth (RE) metal and at least one transition metal (TM).

23. The magnetic recording medium of claim 21, wherein the ferrimagnetic capping layer of the magnetic recording medium comprises TbFeCo.

24. The magnetic recording medium of claim 21, wherein the SUL is configured to provide a return path for magnetic flux from a recording head during one or both of a magnetic write operation and a magnetic read operation.

25. The magnetic recording medium of claim 21, wherein the magnetic recording medium further comprises an underlayer between the heatsink layer and the magnetic recording layer, with the underlayer comprising one or more of MgO and MgO—TiO.

26. The magnetic recording medium of claim 25, further comprising an adhesion layer between the substrate and the SUL, a seed layer between the adhesion layer and the heatsink layer, and a thermal resistive layer between the heatsink layer and the underlayer.

27. The magnetic recording medium of claim 21, wherein the magnetic recording medium further comprises a carbon overcoat on the ferrimagnetic capping layer.
